(19) United States
(12) Patent Application Publication
(10) Pub. No.: US 2011/0304603 A1
(43) Pub. Date: Dec. 15, 2011

(54) NON-VOLATILE LIQUID CRYSTAL DISPLAY DEVICE AND DISPLAY METHOD FOR NON-VOLATILE LIQUID CRYSTAL DISPLAY DEVICE

(75) Inventor: Yuji Ueno, Inagi (JP)

(73) Assignee: FUJITSU FRONTECH LIMITED, Tokyo (JP)

(21) Appl. No.: 13/214,403

(22) Filed: Aug. 22, 2011

Related U.S. Application Data
(63) Continuation of application No. PCT/JP2009/001212, filed on Mar. 18, 2009.

(51) Int. Cl. G09G 5/00

(52) U.S. Cl. 345/211; 345/87

(57) ABSTRACT

A non-volatile liquid crystal display device includes: a liquid crystal display panel which is provided with a plurality of liquid crystal display panels having a scanning signal line group, a data signal line group crossing the scanning signal line group, and a plurality of pixel circuits arranged where these signal line groups cross each other, and includes a non-volatile liquid crystal compound as a liquid crystal layer; a drive unit; a power supply unit; video memory for temporarily storing image data; and a control unit for sequentially transferring the image data stored in the video memory to the liquid crystal display panel. When the control unit receives an image refresh signal for drawing new image data during the transfer, the transfer is canceled with the power supply maintained to the drive unit, and the new image data is stored in the video memory.

### CROSS-REFERENCE TO RELATED APPLICATIONS

This application is a continuation of PCT application PCT/JP2009/001212 which was filed on Mar. 18, 2009, the entire contents of which are incorporated herein by reference.

### FIELD

The present invention relates to a liquid crystal display device for displaying an image by driving a liquid crystal, and more specifically to a non-volatile liquid crystal display device having a memory property applicable to electronic paper etc. and a display method for the non-volatile liquid crystal display device.

### BACKGROUND

Conventionally well known is a liquid crystal display device for filling a liquid crystal compound between a scanning signal line group and a data signal line group which configure a matrix, and forming a number of pixels at a crossing point of the scanning signal line group and the data signal line group, thereby displaying image information. Especially, for example, a cholesteric liquid crystal display device available for electronic paper etc. has a merit of the memory property capable of maintaining display contents even after powering off the device.

With the non-volatile liquid crystal display device, the entire display screen (all pixels) can be refreshed or the display screen can be partially refreshed. In either case, the screen portion to be refreshed is transferred line by line from VRAM storing the screen data to a display panel. However, the transferring process takes a relatively long time, and can cause the next refreshing process to be performed during the transfer of the preceding display data.

Some techniques have been proposed for shortening the screen refreshing time (for example, patent documents 1 and 2).

Patent Document 1: Japanese Laid-open Patent Publication No. 9-81084

Patent Document 2: Japanese Laid-open Patent Publication No.2008-111930

### SUMMARY

According to an aspect of the present invention, the non-volatile liquid crystal display device of the present invention includes: a liquid crystal display panel which is provided with a plurality of liquid crystal display panels having a scanning signal line group, a data signal line group crossing the scanning signal line group, and a plurality of pixel circuits arranged where these signal line groups cross each other, and includes a non-volatile liquid crystal compound as a liquid crystal layer; a drive unit for driving the liquid crystal display panel; a power supply unit for supplying a voltage to the drive unit; video memory for temporarily storing image data for display on the liquid crystal display panel; and a control unit for sequentially transferring the image data stored in the video memory to the liquid crystal display panel. When the control unit receives an image refresh signal for drawing new image data during the transfer, the transfer is canceled with the power supply maintained to the drive unit, and the new image data is stored in the video memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of the non-volatile liquid crystal display device according to the present invention;

FIG. 2 is a flowchart of the display controlling process in an embodiment according to the present invention; and

FIG. 3 is an explanatory view of the effect of an embodiment according to the present invention.

### DESCRIPTION OF EMBODIMENTS

Conventionally, when a cholesteric liquid crystal is driven for drawing an image using a simple matrix, and when the update of the screen is performed during the drawing, the output of the driving power supply of a liquid crystal display panel is temporarily stopped from the viewpoint of power saving, and the image is drawn again by the drawing start trigger from the CPU. Therefore, some time is taken before drawing an image on the new screen, and since 50 ms is required for stabilization as a power supply ON sequence for driving the liquid crystal display panel, a longer time is required to start drawing on the next screen.

The embodiment of the present invention is described below in detail with reference to the attached drawings.

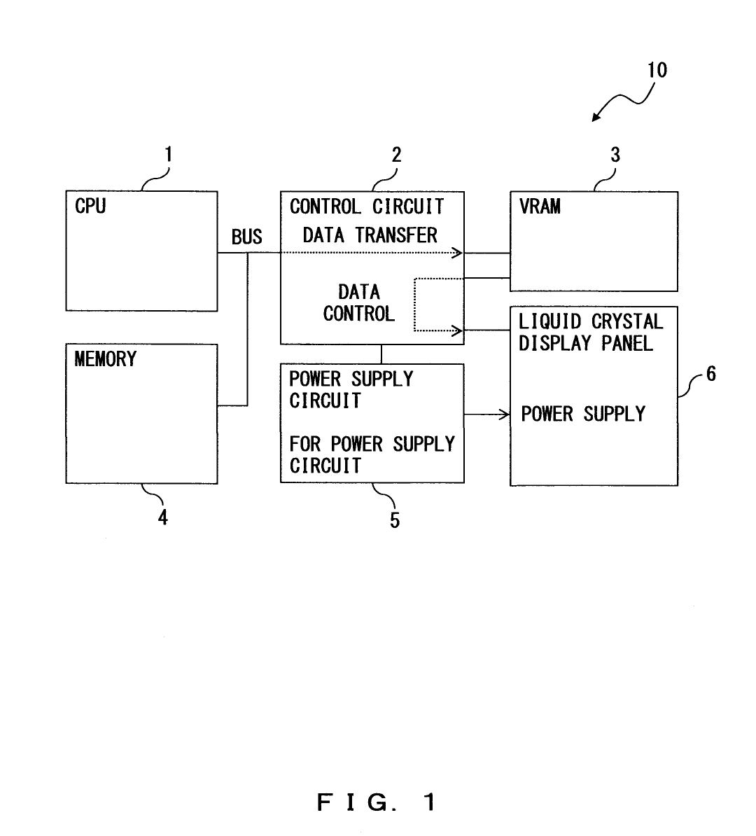

FIG. 1 is a block diagram of the non-volatile liquid crystal display device according to the present invention.

In FIG. 1, a non-volatile liquid crystal display device 10 includes a CPU 1, a control circuit 2, video memory (hereafter referred to as VRAM for short) 3, memory 4, a power supply circuit 5, and a liquid crystal display panel 6.

The liquid crystal display panel 6 has a scanning signal line group, a data signal line group crossing the scanning signal line group, and a plurality of pixel circuits arranged where these signal line groups cross each other. It also includes a non-volatile liquid crystal compound as a liquid crystal layer.

The power supply circuit 5 drives the liquid crystal display panel 6 by supplying a voltage to the drive circuit not illustrated in the attached drawings but driving the liquid crystal display panel 6 under the control of the control circuit 2.

The VRAM 3 temporarily stores the image data to be displayed on the liquid crystal display panel 6 after transferring the data from the memory 4 under the control of the control circuit 2.

The control circuit 2 displays an image by sequentially transferring line by line the image data stored in the VRAM 3 to the liquid crystal display panel 6.

In addition, upon receipt of an image refresh signal for use in drawing new image data from the CPU 1 during the transfer of an image from the VRAM 3 to the liquid crystal display panel 6, the control circuit 2 cancels the transfer with the power supply to the drive circuit maintained. Then, it performs control to store the new image data in the VRAM 3.

Described next is the display controlling process performed by the above-mentioned non-volatile liquid crystal display device 10.

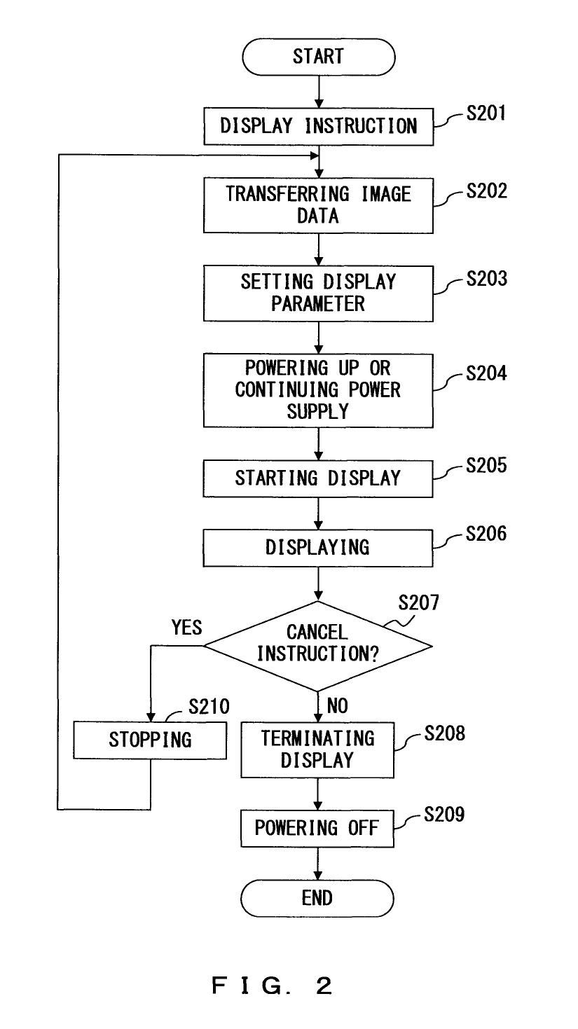

FIG. 2 is a flowchart of the display controlling process in an embodiment of the present invention.

First, in step S201, the CPU 1 issues an instruction to display an image to the control circuit 2. Then, in step S202, the control circuit 2 transfers the image data to be displayed on the liquid crystal display panel 6 from the memory 4, stores the data in the VRAM 3, and sets in step S203 a display parameter to display the image data stored in the VRAM 3 on the liquid crystal display panel 6.

Next, in step S204, when the liquid crystal display panel 6 is powered on, or when the ON state of the power supply is continued, the image data stored in the VRAM 3 is sequentially transferred line by line to the liquid crystal display panel 6 in step S205, thereby starting the display of images on the liquid crystal display panel 6.

Then, in step S206, while images are displayed on the liquid crystal display panel 6, that is, while the images are transferred from the VRAM 3 to the liquid crystal display panel 6, the control circuit 2 receives in step S207 an image refresh signal for use in drawing new image data from the CPU 1, thereby determining whether or not an instruction to cancel displaying an image being drawn has been received.

If it is determined in step S207 that no cancel instruction has been issued (NO in step S207), the display of an image is performed and completed in step S208, and the liquid crystal display panel 6 is powered off in step S209.

On the other hand, if it is determined in step S207 that the cancel instruction has been issued (YES in step S207), the transfer of an image from the VRAM 3 to the liquid crystal display panel 6 is stopped in step S210 with the power supply maintained to the drive circuit for driving the liquid crystal display panel 6, and the processes in and after step S202 are repeated.

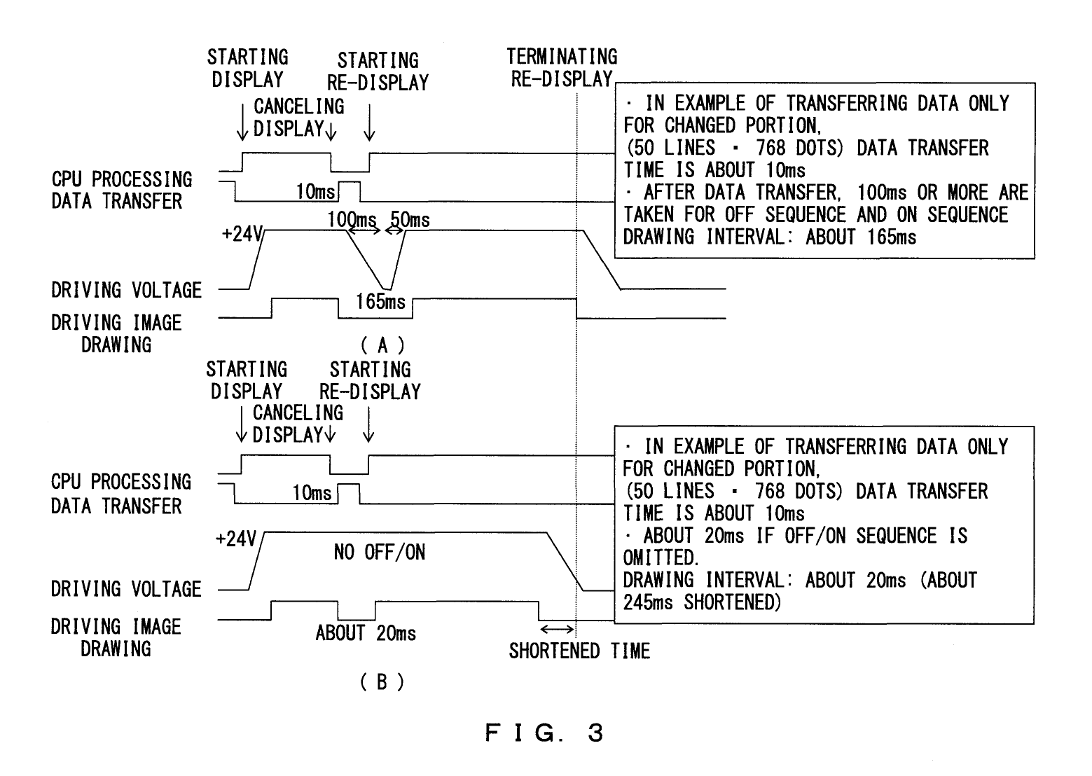

FIG. 3 is an explanatory view of the effect in the embodiment according to the present invention.

As described above with reference to FIGS. 1 and 2, the non-volatile liquid crystal display device 10 according to the present invention omits the ON and OFF sequences (refer to (A) in FIG. 3) of the driving power supply which has been conventionally performed when the cancel instruction is issued in the display controlling process, and the drawing start trigger after the transfer of data is awaited with the voltage of the driving power supply maintained, thereby saving the time for the OFF sequence and the subsequent ON sequence for driving the panel, and reducing the drawing time (refer to (B) in FIG. 3).

For example, when the data transfer is to perform a change when the screen is partially refreshed (50 lines×768 dots), the data transfer time is about 10 ms, which is a reduction from the conventional 150 (100+50) ms. OFF and ON sequences, thereby successfully shortening the entire transfer time into about 20 ms. Thus, the reduction of about 245 ms. can be read. Furthermore, if one line (20 lines d 768 dots) is refreshed, the data transfer time is about 4 ms.

As described above, since the driving power supply is not turned off in the display controlling process performed by the non-volatile liquid crystal display device 10 according to the present invention, the number of the charge and discharge operations of the regulator circuit is reduced, thereby realizing low power consumption.

Thus, the embodiment of the present invention is described above with reference to the attached drawings, but the embodiment of the present invention can be realized by hardware as a function of a non-volatile liquid crystal display device or firmware or software of a DSP (digital signal processor) board and a CPU board.

Furthermore, it is obvious that the non-volatile liquid crystal display device according to the present invention is not limited to the above-mentioned embodiment only if the function can be performed, but can be a single device, a system or an integral device configured by a plurality of devices, or a system in which a process is performed through a network such as a LAN, a WAN, etc.

It can also be realized as a system configured by a CPU, memory such as ROM and RAM, an input device, an output device, an external recording device, a medium drive determine, and a network connection device. That is, it is also obvious that the non-volatile liquid crystal display device can be attained by the memory such as ROM and RAM, the external recording device, and a portable record medium storing the program of the software for realizing the system according to the above-mentioned embodiment provided for the non-volatile liquid crystal display device, and the computer of the non-volatile liquid crystal display device reading and executing the program.

In this case, the program itself read from the portable record medium etc. realizes a new function of the present invention, and the portable record medium etc. storing the program can also configure the present invention.

A portable record medium for providing a program can be, for example, a flexible disk, a hard disk, an optical disk, a magneto optical disk, CD-ROM, CD-R, DVD-ROM, DVD-RAM, magnetic tape, a non-volatile memory card, a ROM card, various record media recording data through network connection devices (that is, communication circuits) such as e-mail, a personal computer communication, etc.

Furthermore, the functions of the above-mentioned embodiment can be realized by a computer (information processing device) executing the program read to memory, and according to the instruction of the program, the OS operated on the computer performs all or a part of the actual process, thereby realizing the functions of the above-mentioned embodiment.

In addition, the program read from the portable record medium and the program provided by a program (data) provider is written to the memory provided for the feature expansion board inserted into the computer or the feature expansion unit connected to the computer, and then according to the instruction of the program, the CPU etc. provided for the feature expansion board or the feature expansion unit performs all or a part of the actual process, thereby realizing the functions of the above-mentioned embodiment.

That is, the present invention is not limited to the embodiments above, but can be realized as various configurations and forms within the gist of the scope of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-volatile liquid crystal display device, comprising:
a liquid crystal display panel which is provided with a plurality of liquid crystal display panels having a scanning signal line group, a data signal line group crossing the scanning signal line group, and a plurality of pixel circuits arranged where these signal line groups cross each other, and includes a non-volatile liquid crystal compound as a liquid crystal layer;
a drive unit driving the liquid crystal display panel;
a power supply unit supplying a voltage to the drive unit;
video memory temporarily storing image data for display on the liquid crystal display panel; and
a control unit sequentially transferring the image data stored in the video memory to the liquid crystal display panel, wherein
when the control unit receives an image refresh signal for drawing new image data during the transfer, the transfer is canceled with the power supply maintained to the drive unit, and the new image data is stored in the video memory.

2. The device according to claim 1, wherein
the liquid crystal layer is a cholesteric liquid crystal layer.

3. A display method of a non-volatile liquid crystal display device, the device comprising:
a liquid crystal display panel which is provided with a plurality of liquid crystal display panels having a scanning signal line group, a data signal line group crossing the scanning signal line group, and a plurality of pixel circuits arranged where these signal line groups cross each other, and includes a non-volatile liquid crystal compound as a liquid crystal layer;
a drive unit driving the liquid crystal display panel;
a power supply unit supplying a voltage to the drive unit;
video memory for temporarily storing image data for display on the liquid crystal display panel; and
a control unit sequentially transferring the image data stored in the video memory to the liquid crystal display panel, wherein
when the control unit receives an image refresh signal for drawing new image data during the transfer, the transfer is canceled with the power supply maintained to the drive unit, and the new image data is stored in the video memory.

4. The method according to claim 3, wherein
the liquid crystal layer is a cholesteric liquid crystal layer.

5. A non-volatile liquid crystal display device, comprising:
a liquid crystal display panel which is provided with a plurality of liquid crystal display panels having a scanning signal line group, a data signal line group crossing the scanning signal line group, and a plurality of pixel circuits arranged where these signal line groups cross each other, and includes a non-volatile liquid crystal compound as a liquid crystal layer;
drive means for driving the liquid crystal display panel;
power supply means for supplying a voltage to the drive means;
video memory temporarily storing image data for display on the liquid crystal display panel; and
control means for sequentially transferring the image data stored in the video memory to the liquid crystal display panel, wherein
when the control means receives an image refresh signal for drawing new image data during the transfer, the transfer is canceled with the power supply maintained to the drive means, and the new image data is stored in the video memory.
